(19) United States
(12) Patent Application Publication
(10) Pub. No.: US 2020/0034794 A1
(43) Pub. Date: Jan. 30, 2020

(54) UNIFIED CONTROL OF EMPLOYEE ACCESS TO EMPLOYER COMMUNICATIONS SYSTEMS DURING PERIODS OF EMPLOYEE FURLOUGH

(71) Applicant: Avaya Inc., Santa Clara, CA (US)

(72) Inventor: John H. Yoakum, Cary, NC (US)

(21) Appl. No.: 16/593,848

(22) Filed: Oct. 4, 2019

Related U.S. Application Data
(63) Continuation of application No. 14/068,513, filed on Oct. 31, 2013.

(51) Int. Cl. G06Q 10/10

(52) U.S. Cl. CPC G06Q 10/105

(57) ABSTRACT

Unified control of employee access to employer communications systems during off-hour periods is disclosed. In one embodiment, a server includes an interface to receive employee information from a user. This information comprises at least one employee indicia identifying at least one off-hour employee and an off-hour period. The server includes a communications interface to communicate with a plurality of employer communications systems. The server includes a control system to receive the employee information and determine restricted employer communications systems for the at least one off-hour employee. These restricted employer communications systems are determined from among the plurality of employer communications systems based on the received employee information. The control system instructs the restricted employer communications systems to restrict communications access of the at least one off-hour employee to the restricted employer communications systems during the off-hour period.

### CROSS-CITATION TO RELATED APPLICATIONS

The present application incorporates by reference U.S. application Ser. No. 14/068,513 filed Oct. 31, 2013 entitled “UNIFIED CONTROL OF EMPLOYEE ACCESS TO EMPLOYER COMMUNICATIONS SYSTEMS DURING PERIODS OF EMPLOYEE FURLOUGH” and presently identified as attorney docket number 4366-962, the entire disclosure of which is hereby incorporated by reference.

### COPYRIGHT NOTICE

A portion of the disclosure of this patent document contains material that is subject to copyright protection. The copyright owner has not objected to the facsimile reproduction by anyone of the patent document or the patent disclosure as it appears in the Patent and Trademark Office patent files or records, but otherwise reserves all copyright rights whatsoever.

### BACKGROUND

### Field of the Disclosure

The technology of the disclosure relates to employee access to employer communications systems.

### Technical Background

Employers commonly provide their employees access to various communications systems for use in performing job-related activities. These communications systems enable the employees to communicate with other employees and/or entities, such as contractors, suppliers, customers, or clients (as non-limiting examples), inside or outside the organization. As non-limiting examples, these communications systems may include telephonic systems (including voicemail), email systems, and instant messaging systems. Outside access to the employer's network through various means, such as a virtual private network (VPN) communications system, may also be provided. Employers may operate enterprise systems and related servers to host such VPN communications systems for access to internal computing resources. In some cases, the employer may provide his or her employees with mobile telephony devices or computing devices with communications capabilities for use in business communications.

There are times when an employee should not access communications systems to perform job-related activities, and the employer should not engage in communications with the employee. This occurs for example when the employee is legally furloughed. A furloughed employee is an employee who is placed on temporary leave due to needs of the employer. The duration of an employee's furlough is variable and can be, for example, as short as a day, or up to weeks or longer. During this time, various laws and policies may forbid the furloughed employee from carrying on his or her job-related activities, and the employer from engaging the employee for job-related duties. This may require that the employee not make any use of the employer's communications systems. However, the employer may be relying on self-compliance of the furloughed employee to abide by these stipulations. The employer may need to educate management or other employees to restrict their communications to furloughed employees. An employer may be subject to legal liability if the employer solicits furloughed employees to perform job-related activities during the furlough. The employer may also be subject to legal liability for facilitating the performance of such job-related activities.

It may be desirable for an employer to not be solely dependent on self-compliance of furloughed employees to not access communications systems for job-related activities.

### SUMMARY

Embodiments disclosed in the detailed description include unified control of employee access to employer communications systems during periods of employee furlough. Related methods, systems, and computer-readable media for providing such unified control are disclosed herein. In one embodiment, a server provides unified control of employee access to a plurality of employer communications systems during periods of employee furlough. The server includes a user interface configured to receive furlough information from a user that indicates an employee or employees to be furloughed. The server includes a control system configured to receive the employee furlough information received by the user interface. The control system determines the restricted employer communications systems for the furlough employee(s). The control system then instructs the restricted employer communications systems to restrict communications access of the furlough employee(s). In this manner, employers are not solely dependent on self-compliance of furloughed employees to not access employer communications systems for job-related activities. The employers are also not dependent on self-compliance of other non-furloughed employees to not engage the furloughed employees using such employer communications systems.

In this regard, in one embodiment, a server provides unified control of employee access to a plurality of employer communications systems during periods of employee furlough. The server comprises a user interface configured to receive employee furlough information from a user. The employee furlough information comprises at least one employee indicia identifying at least one furlough employee and at least one furlough period identifying the period of furlough for the at least one furlough employee. The server also comprises a communications interface configured to communicate with a plurality of employer communications systems. The server also comprises a control system configured to receive the employee furlough information received by the user interface. The control system is also configured to determine restricted employer communications systems for the at least one furlough employee from among the plurality of employer communications systems. This determination is based on the received employee furlough information for the at least one furlough employee. The control system is also configured to instruct the restricted employer communications systems to restrict communications access of the at least one furlough employee to the restricted employer communications systems during the at least one furlough period for the at least one furlough employee.

In another embodiment, a method provides unified control of employee access to a plurality of employer communications systems during periods of employee furlough. The method comprises receiving employee furlough information from a user. The employee furlough information comprises at least one employee indicia identifying at least one furlough employee and at least one furlough period identifying the period of furlough for the at least one furlough employee. The method also comprises determining restricted employer communications systems for the at least one furlough employee from among the plurality of employer communications systems. This determination is based on the received employee furlough information for the at least one furlough employee. The method also comprises instructing the restricted employer communications systems to restrict communications access of the at least one furlough employee to the restricted employer communications systems during the at least one furlough period for the at least one furlough employee.

In another embodiment, a computer-readable medium storing one or more programs is provided. The one or more programs comprise instructions, which when executed by an electronic device cause the electronic device to implement a method. The method provides unified control of employee access to a plurality of employer communications systems during periods of employee furlough. The method comprises receiving employee furlough information from a user. The employee furlough information comprises at least one employee indicia identifying at least one furlough employee and at least one furlough period identifying the period of furlough for the at least one furlough employee. The method also comprises determining restricted employer communications systems for the at least one furlough employee from among the plurality of employer communications systems. This determination is based on the received employee furlough information for the at least one furlough employee. The method also comprises instructing the restricted employer communications systems to restrict communications access of the at least one furlough employee to the restricted employer communications systems during the at least one furlough period for the at least one furlough employee.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 is a block diagram of a furlough communications restriction system including an exemplary server for providing unified control of employee access to employer communications systems during periods of employee furlough;

FIG. 2 is an exemplary graphical user interface (GUI) for providing user input for identifying employees who are on furlough or to be furloughed to the server in FIG. 1, such that the server can provide unified control of the furlough employee access to employer communications systems during periods of employee furlough;

FIG. 3 is a flowchart illustrating exemplary functions of the server in FIG. 1 for providing unified control of employee access to employer communications systems during periods of employee furlough;

FIG. 4 is a state diagram illustrating exemplary furlough states for employees based on their furlough status and state rules that control the employee's furlough status in an embodiment of the operation of the server in FIG. 1;

FIG. 5 is a flowchart illustrating more detailed, exemplary functions of the server in FIG. 1 for providing unified control of employee access to employer communications systems during periods of employee furlough, according to another embodiment;

FIG. 6 is an exemplary calendar for displaying currently scheduled furloughs and for initiating the exemplary calendar GUI of FIG. 8;

FIG. 7 is a flowchart illustrating exemplary functions of the server in FIG. 1 for providing unified control of employee access to employer communications systems during periods of employee furlough, including inserting a calendar entry;

FIG. 8 is an exemplary calendar GUI for providing user input for identifying employees on furlough or to be furloughed to the server in FIG. 1, such that the server can provide unified control of the furlough employee access to employer communications systems during periods of employee furlough;

FIG. 9 is a flowchart illustrating exemplary functions of the server in FIG. 1 for providing unified control of employee access to employer communications systems during periods of employee furlough, using a calendar system;

FIG. 10 is an exemplary administrative GUI for allowing a user to review default employer communications systems restricted to an employee and for allowing the user to select employer communications systems to be restricted for a furlough employee during periods of employee furlough;

FIG. 11 is an exemplary flowchart illustrating the selection of default restricted employer communications systems; and

FIG. 12 is a block diagram of an exemplary processor-based system that can include the server of FIG. 1.

### DETAILED DESCRIPTION

With reference now to the drawing figures, several exemplary embodiments of the present disclosure are described. The word “exemplary” is used herein to mean “serving as an example, instance, or illustration.” Any embodiment described herein as “exemplary” is not necessarily to be construed as preferred or advantageous over other embodiments.

Embodiments disclosed in the detailed description include methods, systems, and computer-readable media for unified control of employee access to employer communications systems during periods of employee furlough. In one embodiment, a server provides unified control of employee access to a plurality of employer communications systems during periods of employee furlough. The server includes a user interface configured to receive furlough information from a user that indicates an employee or employees to be furloughed. The server includes a control system configured to receive the employee furlough information received by the user interface. The control system determines the restricted employer communications systems for the furlough employee(s). The control system then instructs the restricted employer communications systems to restrict communications access of the furlough employee(s). In this manner, employers are not solely dependent on self-compliance of furloughed employees to not access employer communications systems for job-related activities. The employers are also not dependent on self-compliance of other non-furloughed employees to not engage the furloughed employees using such employer communications systems.

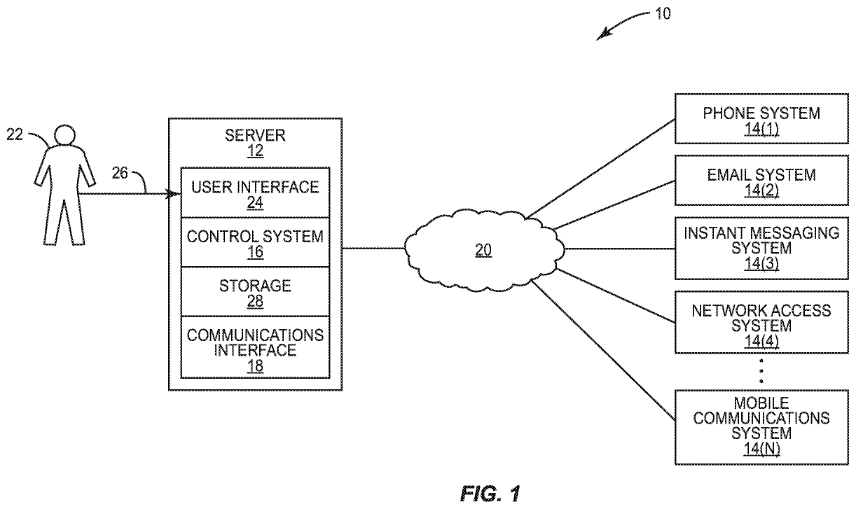

In this regard, FIG. 1 is a block diagram of an exemplary furlough communications restriction system 10. The furlough communications restriction system 10 includes an exemplary server 12 for providing unified control of employee access to a plurality of employer communications systems 14 during periods of employee furlough. Some or all of the plurality of employer communications systems 14 may be restricted employer communications systems 14R. As used herein, an employer communications system is any communications system provided or controlled by an employer that facilitates communications between the employer and employees. For example, as illustrated in FIG. 1, the employer communications systems 14 can include such systems as a phone system 14(1), an email system 14(2), an instant messaging system 14(3), and/or a network access system 14(4), and a mobile communications system 14(N). “N” signifies the number of employer communications systems 14, which are labeled 14(1)-14(N) in FIG. 1. Any number of employer communications systems 14 can be provided by an employer. Also, although the employer communications systems 14 are shown as separate blocks in FIG. 1, any of them may be operated as a single system such as part of an enterprise system or part of the operation of an enterprise server.

A furlough employee is an employee that has been chosen for a furlough. The furlough employee may be an employee that is scheduled to be furloughed in the future or may already be on furlough. When the employee is furloughed by an employer, depending on the nature of the furlough, various laws and policies may forbid the employer from requiring or facilitating the furloughed employee carrying on his or her job-related activities for the employer. An employer may be subject to legal liability if the employer solicits or facilitates furloughed employees to perform job-related activities during the employee's furlough. In this regard, the employer may stipulate that a furlough employee should not access employer communications systems during their period of furlough. In this regard, the employer cannot engage, accidentally or otherwise, the employee during his or her furlough to avoid soliciting the employee to perform job-related activities during his or her furlough. Also, by the furlough employee not accessing employer communications systems during his or her furlough, it is more likely than not that an employee will not perform job-related activities during his or her furlough. In these scenarios, the employer is relying on self-compliance of the furloughed employee to abide by these stipulations. The employer may also need to educate management or other employees to restrict their communications to furloughed employees.

Thus, in the exemplary furlough communications restriction system 10 in FIG. 1, employer communications systems 14(1)-14(N) may be restricted from use by the furlough employee depending on the circumstances and policies of the employer. The exemplary features of the server 12, which is configured to facilitate restricting access by furloughed employees to certain restricted employer communications systems 14R, are described in more detail below.

With continuing reference to FIG. 1, the server 12 in this example includes a control system 16. The control system 16 is communicatively coupled to the employer communications systems 14(1)-14(N) through at least one communications interface 18 networked to the employer communications systems. For example, network 20 is provided in FIG. 1 to couple the at least one communications interface 18 of the control system 16 to the employer communications systems 14(1)-14(N). The control system 16 is configured to instruct one or more of the restricted employer communications systems 14R via the communications interface 18 to restrict communications access of one or more furlough employees. This instruction may be accomplished in different ways depending on the employer communications system 14R to be restricted. Some employer communications systems may accept the restrictions directly. In order to restrict other employer communications systems 14R, it may be necessary to issue provisioning or maintenance commands.

To allow a user 22 to restrict desired employer communications systems 14 to furloughed employees, the server 12 in this example includes a user interface 24. In some embodiments, the furlough employees themselves may access the user interface 24 as user 22 to restrict their employer communications systems 14 for their furlough. In this case, the user 22 may have the authority to initiate the furlough, but may be restricted from having the authority to override their furlough, as discussed in more detail below. This lack of override authority in this example is to provide additional assurance that the employer and furlough employee do not engage each other during the furlough period for the furlough employee.

Alternatively, the user 22 that accesses the user interface 24 to restrict desired employer communications systems 14 to furloughed employees may be an authorized representative of the employer. For example, the user 22 may be a manager, supervisor, executive, information technology representative, or human resources representative of the employer, as non-limiting examples. The user interface 24 of the server 12 is configured to receive employee furlough information 26 from the user 22 indicating the one or more employees to be furloughed. The control system 16 is also configured to receive the employee furlough information 26 received by the user interface 24. The control system 16 determines the restricted employer communications systems 14R for the one or more furlough employees. The server also contains storage 28, which can be used to facilitate one or more of the functions of the server 12, as will be described in more detail below.

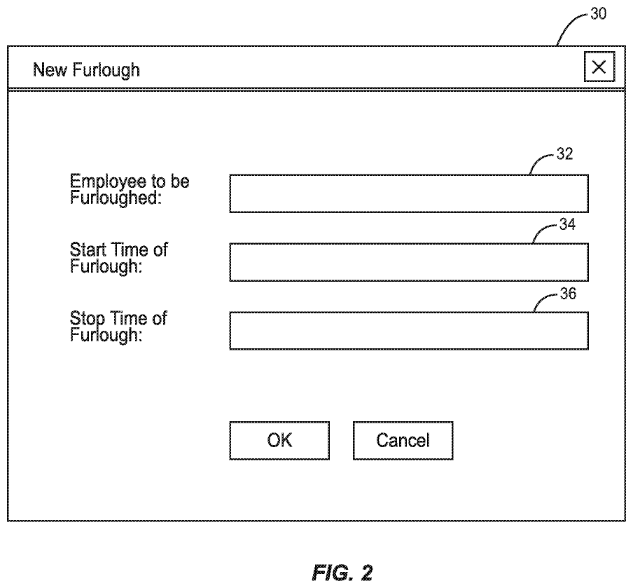

An exemplary graphical user interface (GUI) 30 as illustrated in FIG. 2 is one example of the user interface 24 for providing user input to the server 12 to restrict employee access to the employer communications systems 14 in FIG. 1. This GUI 30 allows the user 22 to provide the server 12 with employee furlough information 26. In this example, the employee furlough information 26 comprises at least one employee indicia identifying at least one furlough employee. The at least one employee indicia can be input to the server 12 using a furlough employee field 32 of the GUI 30. As used herein, the term “indicia” can be both singular and plural. In various embodiments, the employee indicia identifies an individual employee to be furloughed, a group of employees to be furloughed, or both. Also, the employee furlough information 26 comprises at least one furlough period identifying the period of furlough for the at least one furlough employee. The furlough period identifying the period of furlough can be defined or indicated in various ways. In one embodiment, the employee furlough information 26 includes a furlough start time and a furlough stop time. Sometimes the furlough start time and the furlough stop time include only dates, while in other embodiments the time of day is also included. The furlough start time and a furlough stop time can be input to the server 12 using a furlough start time field 34, and a furlough stop time field 36 of the GUI 30, respectively. The furlough employee field 32 includes the employee indicia identifying at least one furlough employee. The furlough start time field 34 and the furlough stop time field 36 together define the at least one furlough period identifying the period of furlough for the at least one furlough employee.

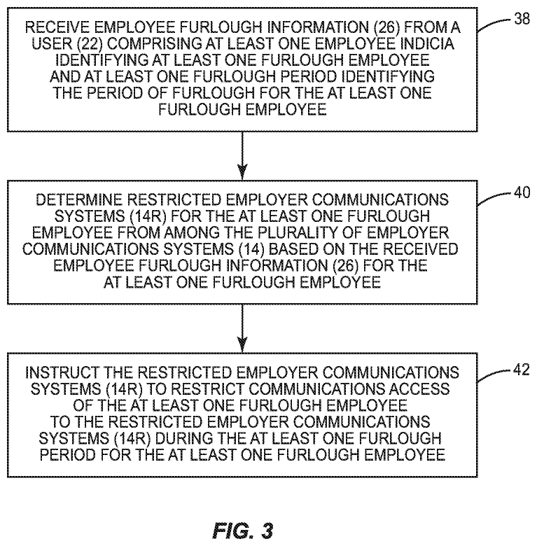

To further explain how the server 12 in FIG. 1 can provide unified control of employee access to employer communications systems 14 during periods of employee furlough, FIG. 3 is provided. FIG. 3 is a flowchart illustrating exemplary functions of the server 12 in FIG. 1 for providing unified control of employee access to employer communications systems 14 during periods of employee furlough. In this regard, as discussed above, to control employee access to employer communications systems 14, the server 12 receives employee furlough information 26 from a user 22. The employee furlough information 26 comprises at least one employee indicia identifying at least one furlough employee, as can be entered into the furlough employee field 32 of the exemplary GUI 30 illustrated in FIG. 2. The employee furlough information 26 also comprises at least one furlough period identifying the period of furlough for the at least one furlough employee (block 38). This furlough period can be determined by, for example, the furlough start time and furlough stop time entered into the furlough start time field 34 and the furlough stop time field 36 of the exemplary GUI 30 illustrated in FIG. 2, respectively.

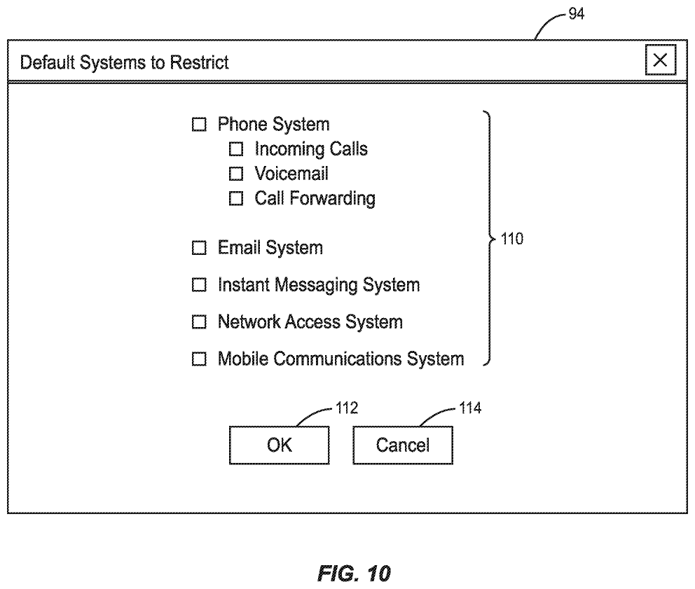

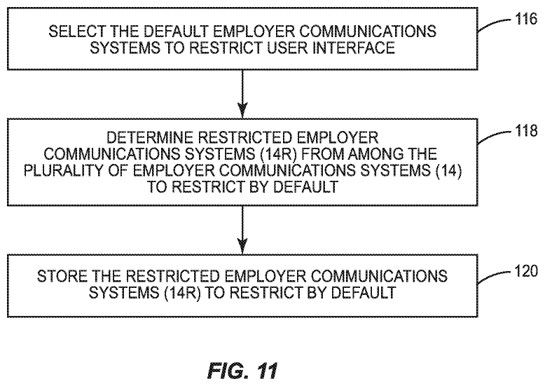

With continuing reference to FIG. 3, based on the received employee furlough information 26 for the at least one furlough employee, the control system 16 determines the employer communications systems 14 to be restricted, which are the restricted employer communications systems 14R, for the at least one furlough employee among the plurality of employer communications systems 14 (block 40). As will be discussed in more detail below, this determination of which employer communications systems 14R to restrict for the at least one furlough employee can be accomplished in various ways. In one embodiment, the employee furlough information 26 includes a list of employer communications systems 14 to be restricted. These may be selected by a user 22 using the user interface 24. In another embodiment, a default list of restricted employer communications systems 14R to be restricted is chosen or restricted by default. This default list can be selected in one embodiment using the GUI 94 of FIG. 10 and the process described in FIG. 11, as will be discussed in more detail below.

Returning again to the process illustrated in FIG. 3, the server 12 instructs the restricted employer communications systems 14R to restrict communications access of the at least one furlough employee to the restricted employer communications systems 14R during the at least one furlough period for the at least one furlough employee (block 42). This instruction can be accomplished in different manners depending on the system to be instructed. For instance, a network access system 14(4) may be instructed to lock out the userid or password of the furlough employee(s). This lockout can either include the time period during which the password should be locked out (the furlough period(s)), or it can be locked indefinitely until the server 12 instructs the network access system 14(4) to restore the communications access of the furloughed employee(s) to the restricted employer communications systems 14R.

As another example, the server 12 may instruct a phone system 14(1) to restrict communications access of the furlough employee(s). This may include instructing the phone system 14(1) to automatically forward all incoming calls for the furlough employee(s) to the voicemail system. The voicemail message played for incoming callers may also indicate that the furlough employee(s) is on furlough or simply unavailable for a period of time without disclosing the furlough status. To provide uniformity and to minimize disruption to employer operations, this voicemail message may be chosen by the user 22 implementing the furlough. It is also possible that the furlough employee(s) can choose the voicemail message from a preapproved set of possible voicemail messages. Alternatively, the incoming calls for the furlough employee(s) could be forwarded to a non-furloughed employee who will be responsible for at least some of the job-related activities of the furlough employee(s). The phone system 14(1) may also be instructed to disable voicemail access by the furlough employee(s). In addition, any mobility features such as call forwarding should be suspended.

The server 12 may also instruct an email system 14(2) or an instant messaging system 14(3). The email system 14(2) may be restricted in similar ways as the phone system 14(1), as discussed above. The server 12 may instruct the email system 14(2) to restrict communications access of the furlough employee(s). This may include instructing the email system 14(2) to automatically reply to all incoming email messages for the furlough employee(s) received by the email system 14(2). The reply email message sent for incoming email messages may indicate that the furlough employee(s) is on furlough or simply unavailable for a period of time without disclosing the furlough status. To provide uniformity and to minimize disruption to employer operations, this reply email message may be chosen by the user 22 implementing the furlough. It is also possible that the furlough employee(s) can choose the reply email message from a preapproved set of possible reply email messages. Alternatively, the incoming email messages for the furlough employee(s) could be forwarded to a non-furloughed employee who will be responsible for at least some of the job-related activities of the furlough employee(s). The email system 14(2) may also be instructed to disable email access by the furlough employee(s). In addition, any mobility features, such as having email forwarded to another email system controlled by the furlough employee, should be suspended. The instant messaging system 14(3) could be likewise restricted or could be instructed to show the furlough employee(s) as unavailable.

Access to a mobile communications system 14(N) might also be restricted. The employer may provide the furlough employee(s) with access to the mobile communications system 14(N), such as by providing a cellular phone with communications capabilities. In one embodiment, the individual capabilities of the cellular phone can be restricted similarly to the restrictions applied to the previously discussed employer communications systems 14 (the network access system 14(4), the phone system 14(1), the email system 14(2), etc.). Alternatively, additional functionality could be included in the cellular phone that would allow access to be restricted in other ways, such as by locking the device or disabling the cellular phone's Subscriber Identity Module (SIM) card.

These examples discussed above are non-limiting examples. The plurality of employer communications systems 14 may include fewer or additional systems. Also, the employer communications systems 14 may be restricted in different manners depending on the applicable legal stipulations, employer policies, and technical limitations of the employer communications systems 14.

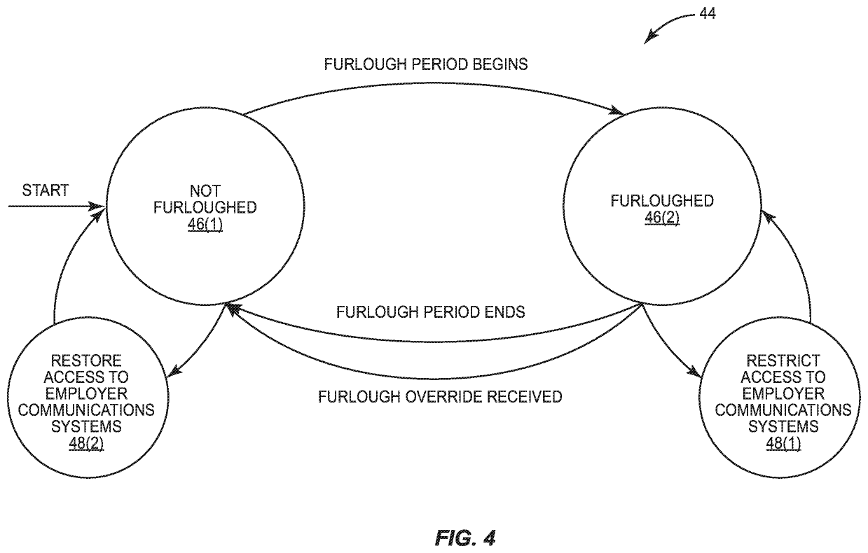

FIG. 4 is a state diagram 44 illustrating exemplary furlough states 46(1) and 46(2) for employees based on their furlough status. The state diagram 44 also includes exemplary state rules that control the employee's furlough status in an embodiment of the operation of the server 12 in FIG. 1. An employee starts in the Not Furloughed state 46(1). In this state, there are no furlough-related restrictions applied to the employee's access to the employer communications systems 14. An employee can be scheduled for furlough. This can result from, for example, the process described in block 38 of FIG. 3, or from the user 22 inputting the relevant information in the exemplary GUI 30 of FIG. 2. When the furlough period begins, the employee's status will change from the Not Furloughed state 46(1) to a Furloughed state 46(2). Upon entering the Furloughed state 46(2), the employee is transitioned to the Restrict Access to Employer Communications Systems state 48(1). While in this state, the employee's access to restricted employer communications systems 14R is restricted. This can be accomplished by, for example, the process described in blocks 40 and 42 of FIG. 3. Upon completion of these restrictions, the employee is returned to the Furloughed state 46(2).

The employee remains in the Furloughed state 46(2) until one of two events occur. First, if the furlough period ends, the server 12 will change the employee's status from the Furloughed state 46(2) to the Not Furloughed state 46(1). This corresponds to the predetermined end of the furlough. This can be determined for example by the furlough stop time as input by the user 22 in the furlough stop time field 36 of the exemplary GUI 30 of FIG. 2. Alternatively, if the employer determines that the employee's scheduled furlough should end prematurely, the employer may request that the employee's furlough be overridden. This situation might occur, for example, if the reason for the employee furlough is no longer valid. This might also occur if the employer's need to have the employee come back to work before the furlough employee's period of furlough ends overrides the reason for the furlough. This might be the result of a changed circumstance, a new project, or any other need, as examples. When the server 12 receives furlough override information that includes employee indicia identifying the employee, the furlough of the furlough employee will be ended before the furlough period ends. In this case, the server 12 will change the employee's status from the Furloughed state 46(2) to the Not Furloughed state 46(1).

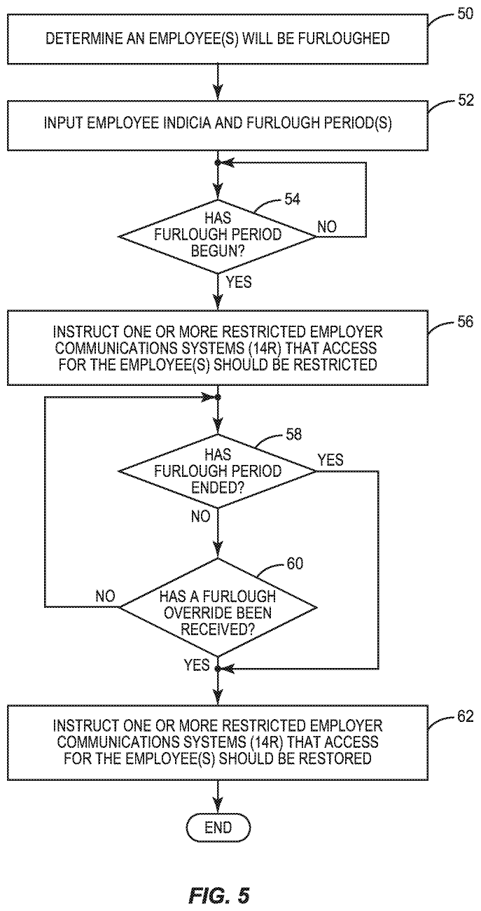

Upon the employee entering the Not Furloughed state 46(1) from the Furloughed state 46(2), the server 12 transitions the employee to the Restore Access to Employer Communications Systems state 48(2). While in the Restore Access to Employer Communications Systems state 48(2), the employee's communications access to the restricted employer communications systems 14R is restored. In this example, the employee's communications access is returned to the state the employee's communications access was in before the restriction occurred. This can be accomplished in many ways and will be discussed in more detail below in relation to FIG. 5. The employee will remain in the Not Furloughed state 46(1) until another furlough period begins, as discussed above.

FIG. 5 is a flowchart illustrating more detailed, exemplary functions of the server in FIG. 1 for providing unified control of employee access to employer communications systems 14 during periods of employee furlough, according to another embodiment. This flowchart starts with a user 22 determining that one or more employees will be furloughed (block 50). The user 22 then inputs one or more employee indicia and one or more furlough periods (block 52). The user 22 inputs this employee furlough information 26 using the user interface 24 of the server 12. The user interface 24 could be the exemplary GUI 30 of FIG. 2 or could be any programmatic interface to receive furlough information 26 from one or more other systems. The server 12 then determines whether any of the one or more furlough periods has begun (block 54). If none of the one or more furlough periods has begun, the system waits to check again. The amount of time between checking is dependent on the implementation of the system. For instance, if the furlough time period is defined using only days, the server 12 would only need to check for the beginning of a furlough once per day. Alternatively, if the precision of the furlough period allows for defining the minute of the start or stop time, the server 12 would need to check for the beginning of a furlough once per minute. Alternatively, other well known techniques can be used to trigger the beginning of a furlough period such as database event triggers and the like. These are merely non-limiting examples, and the actual times or triggers will depend on the specific implementation of the server 12.

If the server 12 determines that one or more furlough periods has begun (block 54), the server 12 instructs one or more restricted employer communications systems 14R that access by the one or more employees should be restricted (block 56). This instruction can be accomplished in different manners depending on the system to be instructed, as discussed above in detail with regard to block 42 in FIG. 3. The affirmative answer to block 54 corresponds to the transition from the Not Furloughed state 46(1) to the Furloughed state 46(2) in the state diagram 44 of FIG. 4. Similarly, the process of block 56 corresponds to the transition from the Furloughed state 46(2) to the Restrict Access to Employer Communications Systems state 48(1), also in the state diagram 44 of FIG. 4.

Returning to FIG. 5, the server 12 determines whether one of two events has occurred that would initiate a transition of the employee's status from the Furloughed state 46(2) to the Not Furloughed state 46(1) in the state diagram 44 of FIG. 4. First, the server 12 determines whether any of the one or more furlough periods has ended (block 58). Second, the server 12 determines whether a furlough override has been received for the one or more employees (block 60). In some embodiments, this determination may involve determining whether the user 22 who submitted the furlough override information or some other user requesting the override has the authority to end a furlough before the furlough's scheduled conclusion.

If one of the questions in blocks 58 and 60 is answered in the affirmative, the furlough is over and the effects need to be reversed. This is accomplished by instructing the one or more restricted employer communications systems 14R that access by the one or more employees should be restored (block 62). The affirmative answer to block 58 or 60 corresponds to the transition from the Furloughed state 46(2) to the Not Furloughed state 46(1) in the state diagram 44 of FIG. 4. Similarly, the process of block 62 corresponds to the transition from the Not Furloughed state 46(1) to the Restore Access to Employer Communications Systems state 48(2), also in the state diagram 44 of FIG. 4.

The instruction of the one or more restricted employer communications systems 14R can be accomplished in different manners depending on the system to be instructed. For instance, a network access system 14(4) may be instructed to unlock the userid or password of the furlough employee(s). As another example, the server 12 may instruct a phone system 14(1) to restore communications access of the furlough employee(s). This may include instructing the phone system 14(1) to cease automatically forwarding all incoming calls for the furlough employee(s) to the voicemail system. The voicemail message played for incoming callers may also be restored to the state it was in before the furlough began. Alternatively, if the incoming calls for the furlough employee(s) were forwarded to a non-furloughed employee, then that forwarding should cease. The phone system 14(1) may also be instructed to restore voicemail access by the furlough employee(s). In addition, any mobility features such as call forwarding should be restored.

The server 12 may also instruct an email system 14(2) or an instant messaging system 14(3). The email system 14(2) may be restored in similar ways as the phone system 14(1), as discussed above. The server 12 may instruct the email system 14(2) to restore communications access of the furlough employee(s). This may include instructing the email system 14(2) to cease automatically replying to all incoming email messages for the furlough employee(s). In addition, any mobility features such as email forwarding should be restored.

Access to a mobile communications system 14(N) might also have been restricted. If so, the mobile communications system 14(N) should be instructed to restore access for the furlough employee(s). In one embodiment, the individual capabilities of the cellular phone are restricted in a similar manner to the manners used for previously discussed employer communications systems 14 (network access system 14(4), phone system 14(1), email system 14(2), etc.). These systems can be restored individually as discussed above. Alternatively, if access to the cellular phone is restricted using additional functionality included to restrict access, then the access can be restored by unlocking the device or enabling the cellular phone's SIM card.

These are merely non-limiting examples. The restricted employer communications systems 14R may include fewer or additional systems. Also, the restricted employer communications systems 14R may be restored in different manners depending on how they were restricted.

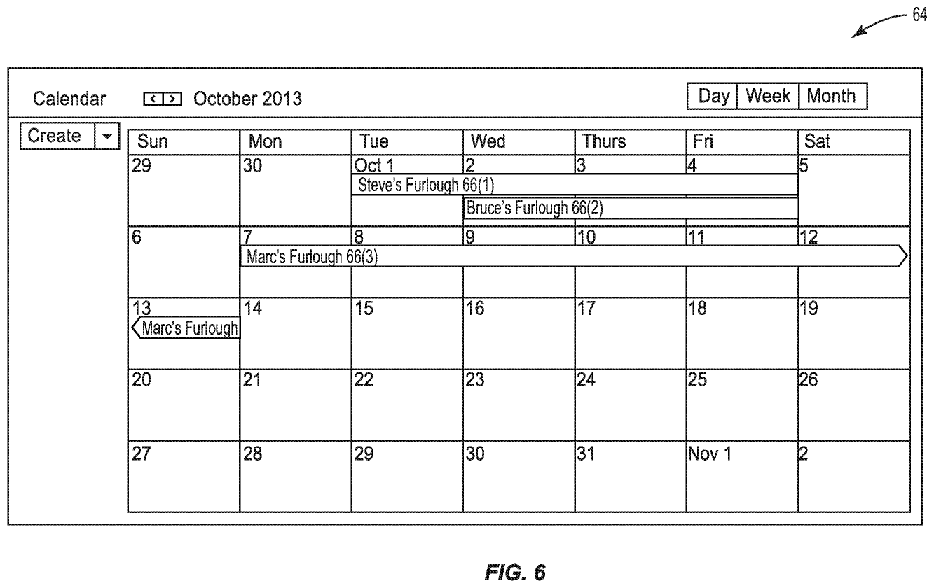

There may be times when it is advantageous to view currently scheduled furloughs on a calendar. The calendar could aid a user 22 in understanding which employees are furloughed at different times. This understanding could help the user 22 decide when a new furlough should be scheduled, and it could also help the user 22 determine if the furlough of one or more of the furlough employees should be overridden. In this regard, FIG. 6 is an exemplary calendar 64 for displaying currently scheduled furloughs. Depending on the embodiment, this calendar 64 may be visible to only a select group, may be accessible to all of the employer's employees, or may be available more broadly. In some embodiments the calendar 64 may consist of display of furlough information as entries in a general purpose calendar system such as that provided by typical office software where the furlough communications restriction system 10 provides furlough information through application programming interfaces or data interfaces provided by the office software.

The calendar 64 includes three calendar entries 66(1)-66(3). Calendar entry 66(1) has a title of “Steve's Furlough”, begins on Oct. 1, 2013, and ends on Oct. 4, 2013. The second calendar entry 66(2) is titled “Bruce's Furlough” and is shorter than calendar entry 66(1). Calendar entry 66(2) begins the day after calendar entry 66(1) on Oct. 2, 2013 and ends on the same day as calendar entry 66(1). “Marc's Furlough” is the title of the longest calendar entry 66(3). The calendar entry 66(3) is a week long, starting on Monday, Oct. 7, 2013 and running through Sunday, Oct. 13, 2013.

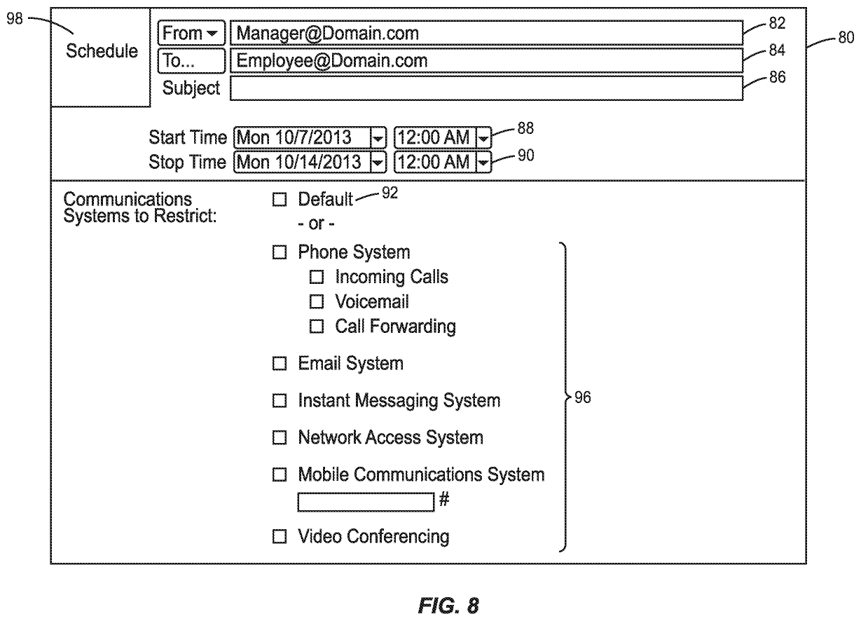

Using the calendar 64, a user 22 could see which employees are currently scheduled for furlough and on which days. For example, the user 22 might want to furlough an additional employee during the month of October. By consulting the calendar 64, the user 22 may decide to avoid scheduling the new furlough during Oct. 2, 2013 through Oct. 4, 2013 because there are already two employees scheduled for furlough during those days. This is shown in calendar 64 by the overlapping calendar entries 66(1) and 66(2). As another example, if the additional employee to be furloughed works in a group with “Marc” (the employee referred to in calendar entry 66(3)), then the user 22 may wish to avoid scheduling the new furlough during the week denoted by calendar entry 66(3) because that might leave the group with too few workers during that time. One skilled in the art will recognize that furlough scheduling could begin by selection of a timeframe in a calendar that would open a GUI for completing the scheduling as is common in calendar systems. One instance of such a GUI is described below in relation to FIG. 8.

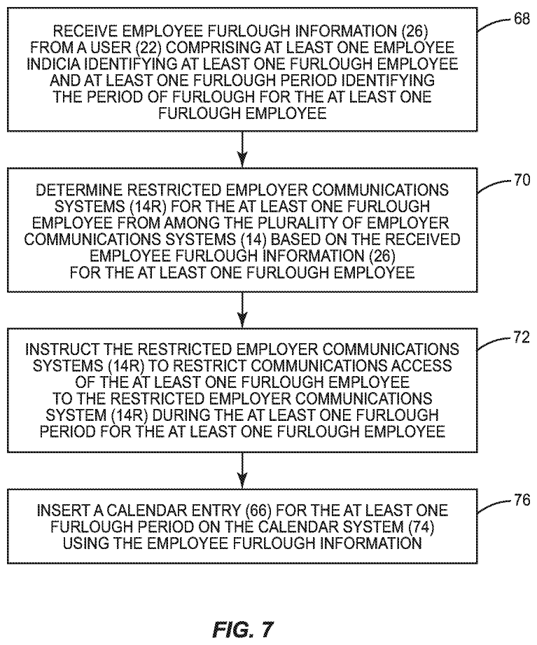

FIG. 7 is a flowchart illustrating exemplary functions of the server 12 (shown in FIG. 1). These functions are similar to the functions illustrated in FIG. 3. The functions additionally include the insertion of a calendar entry 66 on a calendar 64, according to one embodiment. In this regard, as discussed above, to control employee access to employer communications systems 14, the server 12 receives employee furlough information 26 from a user 22. The employee furlough information 26 comprises at least one employee indicia identifying at least one furlough employee, as can be entered into the furlough employee field 32 of the exemplary GUI 30 illustrated in FIG. 2. The employee furlough information 26 also comprises at least one furlough period identifying the period of furlough for the at least one furlough employee (block 68).

Based on the received employee furlough information 26 for the at least one furlough employee, the control system 16 determines the restricted employer communications systems 14R to be restricted for the at least one furlough employee from among the plurality of employer communications systems 14 (block 70). The server 12 instructs the restricted employer communications systems 14R to restrict communications access of the at least one furlough employee to the restricted employer communications systems 14R during the at least one furlough period for the at least one furlough employee (block 72). This instruction can be accomplished in different manners depending on the system to be instructed, as was discussed in detail above.

Then, the server 12 inserts a calendar entry 66 on a calendar system 74. The calendar entry 66 is for the at least one furlough period and uses the employee furlough information 26 (block 76). The calendar entry 66 can use the furlough period included in the employee furlough information 26 to display the beginning and end of the furlough on the calendar system 74. The calendar entry 66 can also use the at least one employee indicia to create a title, according to one embodiment. In another embodiment, information indicating which employer communications systems 14R are restricted for the one or more employees during the at least one furlough period is also included in the calendar entry 66.

In another embodiment, a calendar system 78 instructs the restricted employer communications systems 14R to restrict communications access of the at least one furlough employee. In this regard, FIG. 8 is an exemplary calendar GUI 80 for providing user input. The calendar GUI 80 is one example of the user interface 24 for providing user input to the server 12. This user input includes employee furlough information 26 for identifying employees to be furloughed. The calendar GUI 80 includes a furlough manager field 82 for inputting the employee indicia of the user 22 who is initiating the furlough. As described above, the server 12 may include methods both for authenticating the user 22 and for ensuring that the user 22 has the proper authority to initiate a furlough of the one or more employees to be furloughed. The calendar GUI 80 also includes a furlough employee field 84 configured to receive the at least one employee indicia. In the calendar GUI 80 of FIG. 8, both the furlough manager field 82 and the furlough employee field 84 are shown accepting email addresses. This is only a preferred embodiment and is used in this example to facilitate the use of a calendar entry 66.

The calendar GUI 80 may include a subject field 86 that allows the user 22 to include any additional information that might be desirable to include. The calendar GUI 80 also includes a furlough start time field 88 and a furlough stop time field 90 that together define the at least one furlough period. As discussed above with regard to the furlough start time field 34 and the furlough stop time field 36, the furlough start time field 88 and the furlough stop time field 90 can accept many different formats depending on the implementation. In FIG. 8, the furlough start time field 88 and the furlough stop time field 90 are shown accepting both a date and a time of day. Finally, the calendar GUI 80 of FIG. 8 provides two mutually exclusive options for indicating which employer communications systems 14R to restrict during the furlough period. There is a default communications systems field 92, which indicates that the server 12 should restrict the default restricted employer communications systems 14R during the furlough period. This default setting can be changed by, for example, using the administrative GUI 94 shown in FIG. 10 and the process described in FIG. 11, as will be discussed in more detail below.

Returning now to FIG. 8, there is also a plurality of communications systems fields 96 which can be used to select which employer communications systems 14R to restrict during the furlough period. If the default communications systems field 92 is selected, the plurality of communications systems fields 96 becomes unavailable. Otherwise, the user 22 can select which employer communications systems 14R to restrict by selecting either an individual system, such as “Phone System,” or a specific feature of some individual system, such as “Voicemail.” As mentioned above, the decision about which employer communications systems 14R to restrict can be influenced by the legal requirements for such a furlough, and may be based on the circumstances and policies of the employer. Finally, there is a Schedule button 98 that causes the calendar GUI 80 to provide the employee furlough information 26 to the control system 16 of the server 12 (shown in FIG. 1).

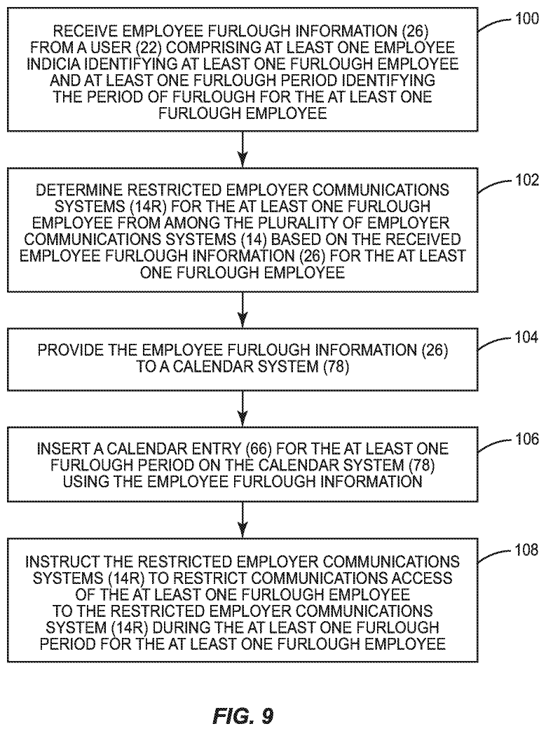

FIG. 9 is provided to further explain how the calendar GUI 80 of FIG. 8 can provide information to the server 12 of FIG. 1 to provide unified control of employee access to employer communications systems 14 during periods of employee furlough. FIG. 9 is a flowchart illustrating exemplary functions of the server 12 that are similar to those functions illustrated in FIG. 3, but also include the use of a calendar system 78 to instruct the restricted employer communications systems 14R, according to one embodiment. In this regard, as discussed above, to control employee access to employer communications systems 14, the server 12 receives employee furlough information 26 from the user 22. The employee furlough information 26 comprises at least one employee indicia identifying at least one furlough employee, as can be entered into the furlough employee field 84 of the exemplary calendar GUI 80 illustrated in FIG. 8. The employee furlough information 26 also comprises at least one furlough period identifying the period of furlough for the at least one furlough employee (block 100).

Based on the received employee furlough information 26 for the at least one furlough employee, the control system 16 (shown in FIG. 1) determines the restricted employer communications systems 14R for the at least one furlough employee from among the plurality of employer communications systems 14 (block 102).

In this embodiment, the server 12 provides the employee furlough information 26 to a calendar system 78 for the creation of a calendar entry 66 related to the furlough (block 104). The calendar system 78 then inserts a calendar entry 66 in the calendar system 78. The calendar entry 66 is for the at least one furlough period and uses the employee furlough information 26 (block 108). The calendar entry 66 can use the furlough period included in the employee furlough information 26 to display the beginning and end of the furlough in the calendar system 78. The calendar entry 66 can also use the at least one employee indicia to create a title, according to one embodiment. In another embodiment, information indicating which employer communications systems 14R are restricted for the one or more employees during the one or more furlough periods is also included in the calendar entry 66.

The calendar system 78 then instructs the restricted employer communications systems 14R to restrict communications access of the at least one furlough employee to the restricted employer communications systems 14R during the at least one furlough period for the at least one furlough employee (block 106). This instruction can be accomplished in different manners depending on the system to be instructed, as is discussed in detail above.

In some embodiments, as has been previously discussed, it is advantageous to determine a set of restricted employer communications systems 14R to restrict by default. This may serve as a convenience for the user 22 initiating the furlough. It may also serve as a method for maintaining compliance with the various legal requirements and employer policies regarding furloughed employees. This default set of restricted employer communications systems 14R would be used for example when the user 22 uses the GUI 30 of FIG. 2 that does not have for a way of selecting otherwise. The default selection can also be used if, for example, the default communications systems field 92 of the calendar GUI 80 of FIG. 8 is selected.

In this manner, FIG. 10 is an exemplary administrative GUI 94 for allowing the user 22 to review default restricted employer communications systems 14R that are restricted to an employee. The administrative GUI 94 also allows the user 22 to select employer communications systems 14R to be restricted by default for a furlough employee during the period of the employee furlough. The administrative GUI 94 includes a plurality of communications systems fields 110 which can be used to select which employer communications systems 14 to restrict by default during the furlough period. In one embodiment, this list is populated with the current default settings when the administrative GUI 94 is selected. This may enable the user 22 to more easily make changes to the current default settings without being required to recreate the full default settings. The administrative GUI 94 also includes an “OK” button 112 and a “Cancel” button 114. The “OK” button 112 stores the currently selected restricted employer communications systems 14R to the storage 28 (shown in FIG. 1) of the server 12. The “Cancel” button 114 exits the administrative GUI 94 and does not alter the selection of restricted employer communications systems 14R previously stored in the storage 28 of the server 12.

To further explain how the administrative GUI 94 of FIG. 10 can be used by the user 22 to provide information to the server 12 about which employer communications systems 14R to restrict by default, FIG. 11 is provided. FIG. 11 is an exemplary flowchart illustrating the selection of default restricted employer communications systems 14R. The user 22 first selects the Default Systems to Restrict user interface (block 116). The user 22 then determines the restricted employer communications systems 14R to restrict by default from among the plurality of employer communications systems 14 (block 118). As discussed previously, this determination can be influenced by the legal requirements for such a furlough, and/or may be based on the circumstances and policies of the employer. Then, the GUI 24 stores the currently selected restricted employer communications systems 14R to the storage 28 (shown in FIG. 1) of the server 12 (block 120).

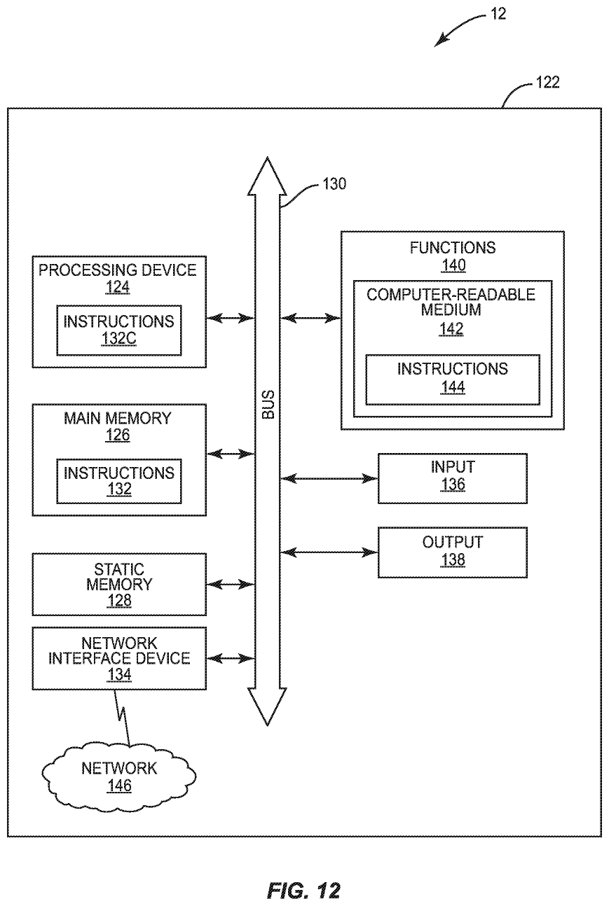

FIG. 12 provides a schematic diagram representation of a server 12 in the form of an exemplary computer system 122 adapted to execute instructions from an exemplary computer-readable medium to perform the functions described herein. In this regard, the server 12 may comprise the computer system 122 within which a set of instructions for causing the server 12 to perform any one or more of the methodologies discussed herein may be executed. The server 12 may be connected (as a non-limiting example, networked) to other machines in a local area network (LAN), an intranet, an extranet, or the Internet. The server 12 may operate in a client-server network environment, or as a peer machine in a peer-to-peer (or distributed) network environment. While only a single server 12 is illustrated, the term “server” shall also be taken to include any collection of machines that individually or jointly execute a set (or multiple sets) of instructions to perform any one or more of the methodologies discussed herein. The server 12 may be a server, a personal computer, a desktop computer, a laptop computer, a personal digital assistant (PDA), a computing pad, a mobile device, or any other device, and may represent, as non-limiting examples, a server or a user's computer.

The exemplary computer system 122 includes a processing device or processor 124, a main memory 126 (as non-limiting examples, read-only memory (ROM), flash memory, dynamic random access memory (DRAM) such as synchronous DRAM (SDRAM), etc.), and a static memory 128 (as non-limiting examples, flash memory, static random access memory (SRAM), etc.), which may communicate with each other via a bus 130. Alternatively, the processing device 124 may be connected to the main memory 126 and/or the static memory 128 directly or via some other connectivity means.

The processing device 124 represents one or more processing devices such as a microprocessor, central processing unit, or the like. More particularly, the processing device 124 may be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 124 is configured to execute processing logic in instructions 132 and/or cached instructions 132C for performing the operations and steps discussed herein.

The computer system 122 may further include a communications interface in the form of a network interface device 134. It also may or may not include an input 136 to receive input and selections to be communicated to the computer system 122 when executing instructions. It also may or may not include an output 138, including but not limited to display(s), a video display unit (as non-limiting examples, a liquid crystal display (LCD) or a cathode ray tube (CRT)), an alphanumeric input device (as a non-limiting example, a keyboard), a cursor control device (as a non-limiting example, a mouse), and/or a touch screen device (as a non-limiting example, a tablet input device or screen).

The computer system 122 may or may not include a data storage device that includes using drive(s) to store functions 140 herein described in a computer-readable medium 142 on which is stored one or more sets of instructions 144 (e.g., software) embodying any one or more of the methodologies or functions 140 described herein. The functions 140 can include the methods described in FIGS. 3, 5, 7, 9, and 11 and/or other functions of the server 12, as non-limiting examples. The instructions 144 may also reside, completely or at least partially, within the main memory 126 and/or within the processing device 124 during execution thereof by the computer system 122, the main memory 126 and the processing device 124 also constituting machine-accessible storage media. The instructions 132, 132C and 144 may further be transmitted or received over a network 146 via the network interface device 134. The network 146 can be an intra-network or an inter-network.

While the computer-readable medium 142 is shown in an exemplary embodiment to be a single medium, the term “machine-accessible storage medium” should be taken to include a single medium or multiple media (as non-limiting examples, a centralized or distributed database, and/or associated caches and servers) that store the one or more sets of instructions. The term “machine-accessible storage medium” shall also be taken to include any medium that is capable of storing, encoding or carrying a set of instructions for execution by the machine and that cause the machine to perform any one or more of the methodologies of the embodiments disclosed herein. The term “machine-accessible storage medium” shall accordingly be taken to include, but not be limited to, solid-state memories, optical and magnetic media, and carrier wave signals.

Methods, systems, and computer-readable media for unified control of employee access to employer communications systems during periods of employee furlough, according to embodiments disclosed herein may be provided in or integrated into any processor-based device. Examples, without limitation, include a set top box, an entertainment unit, a navigation device, a communications device, a fixed location data unit, a mobile location data unit, a mobile phone, a cellular phone, an internet phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

Those of skill in the art will further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The arbiters, master devices, and slave devices described herein may be employed in any circuit, hardware component, integrated circuit (IC), or IC chip, as non-limiting examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a processor, a digital signal processor (DSP), an Application Specific Integrated Circuit (ASIC), an field programmable gate array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, as non-limiting examples, a combination of a DSP and a microprocessor, a plurality of microprocessors, one or more microprocessors in conjunction with a DSP core, or any other such configuration.

The embodiments disclosed herein may be embodied in hardware and in instructions that are stored in hardware, and may reside, as non-limiting examples, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an Application Specific Integrated Circuit (ASIC). The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. It is to be understood that the operational steps illustrated in the flowchart diagrams may be subject to numerous different modifications as will be readily apparent to one of skill in the art. Those of skill in the art would also understand that information and signals may be represented using any of a variety of different technologies and techniques. As non-limiting examples, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A server for providing unified control of employee access to a plurality of employer communications systems during off-hour periods, comprising:
an interface configured to receive employee information from a user, the employee information, comprising:
at least one employee indicia identifying at least one off-hour employee; and
at least one period identifying an off-hour period for the at least one off-hour employee;
a communications interface configured to communicate with the plurality of employer communications systems; and
a control system configured to:
determine restricted employer communications systems for the at least one off-hour employee from among the plurality of employer communications systems based on the received employee information for the at least one off-hour employee; and
instruct the restricted employer communications systems to restrict communications access of the at least one off-hour employee to the restricted employer communications systems during the at least one off-hour periods for the at least one off-hour employee.

2. The server of claim 1, wherein the plurality of employer communications systems comprises at least one of a telephonic system, a voicemail system, an email system, an instant messaging system, a network access system, a mobile communications system, a collaboration system, a video interaction system, a real-time web communications system or application, a WebRTC interaction system or application, a paging system, a push-to-talk system, and a computing device having a communications system.

3. The server of claim 1, wherein the at least one employee indicia identifying the at least one off-hour employee is comprised of an employee group indicia identifying a group of off-hour employees.

4. The server of claim 1 comprised of a cloud server used by an enterprise.

5. The server of claim 1, wherein the control system is further configured to determine the restricted employer communications systems for the at least one off-hour employee based on a default restricted communications systems setting.

6. The server of claim 1, wherein the interface is further configured to receive a list of restricted employer communications systems from the user; and
the control system is further configured to determine the restricted employer communications systems based on the received list of restricted employer communications systems from the interface.

7. The server of claim 1, wherein the at least one period comprises at least one off-hour start time and at least one off-hour stop time;
wherein the control system is configured to instruct the restricted employer communications systems to restrict the communications access by being configured to:
instruct the restricted employer communications systems to restrict communications access of the at least one off-hour employee to the restricted employer communications systems at the at least one off-hour start time; and
instruct the restricted employer communications systems to restore the communications access of the at least one off-hour employee to the restricted employer communications systems at the least one off-hour stop time.

8. The server of claim 7, wherein the interface is comprised of a graphical user interface, comprising:
an employee field configured to receive the at least one employee indicia;
an off-hour start time field configured to receive the at least one off-hour start time; and
an off-hour stop time field configured to receive the at least one off-hour stop time.

9. The server of claim 8, wherein the graphical user interface further comprises:
a default communications systems field; and
a plurality of communications systems fields; and
the control system is further configured to:
determine the restricted employer communications systems based on a default restricted communications system setting if the default communications systems field is selected; and
determine the restricted employer communications systems based on the plurality of communications systems fields if the default communications systems field is not selected.

10. The server of claim 1, wherein the control system is further configured to:
instruct the restricted employer communications systems, by being configured to provide the employee information to a calendar system;
wherein the calendar system is configured to:
instruct the restricted employer communications systems to restrict the communications access of the at least one off-hour employee to the restricted employer communications systems during the at least one off-hour period for the at least one off-hour employee; and
insert a calendar entry for the at least one off-hour period on the calendar system using the employee information.

11. The server of claim 10, wherein the interface is comprised of a graphical user interface, comprising:
an employee field configured to receive the at least one employee indicia;
an off-hour period field configured to receive the at least one off-hour period; and
a schedule button configured to provide the employee information to the control system; and
the at least one employee indicia is comprised of at least one email address.

12. The server of claim 1, wherein the control system is further configured to:
access a calendar system; and
insert a calendar entry for the at least one off-hour period on the calendar system using the employee information.

13. The server of claim 1, wherein the control system is further configured to:
determine that the at least one off-hour period identifying the off-hour period for the at least one off-hour employee has ended; and
instruct the restricted employer communications systems to restore the communications access of the at least one off-hour employee to the restricted employer communications systems.

14. The server of claim 1, wherein the interface is further configured to receive override information from the user, the override information comprising at least one employee indicia identifying at least one off-hour employee to no longer be off-hour; and
the control system is further configured to:
instruct the restricted employer communications systems to restore the communications access of the at least one off-hour employee to the restricted employer communications systems based on the received override information.

15. A method for providing unified control of employee access to a plurality of employer communications systems during off-hour periods, comprising:
receiving employee information from a user, the employee information comprising at least one employee indicia identifying at least one off-hour employee and at least one off-hour period identifying the off-hour period for the at least one off-hour employee;
determining restricted employer communications systems for the at least one off-hour employee from among the plurality of employer communications systems based on the received employee information for the at least one off-hour employee; and
instructing the restricted employer communications systems to restrict communications access of the at least one off-hour employee to the restricted employer communications systems during the at least one off-hour period for the at least one off-hour employee.

16. The method of claim 15, wherein determining the restricted employer communications systems comprises determining the restricted employer communications systems for the at least one off-hour employee based on a default restricted communications systems setting.

17. The method of claim 15, wherein determining the restricted employer communications systems comprises determining the restricted employer communications systems based on a received list of restricted employer communications systems.

18. The method of claim 15, wherein:
the at least one off-hour period comprises at least one off-hour start time and at least one off-hour stop time; and
instructing the restricted employer communications systems, comprises:
instructing the restricted employer communications systems to restrict communications access of the at least one off-hour employee to the restricted employer communications systems at the at least one off-hour start time; and
instructing the restricted employer communications systems to restore the communications access of the at least one off-hour employee to the restricted employer communications systems at the least one off-hour stop time.

19. The method of claim 15, further comprising inserting a calendar entry for the at least one off-hour period on a calendar system using the employee information.

20. A computer-readable medium storing one or more programs, the one or more programs comprising instructions, which when executed by an electronic device cause the electronic device to implement a method for providing unified control of employee access to a plurality of employer communications systems during off-hour periods, the method comprising:
receiving employee information from a user, wherein the employee information includes at least one employee indicia identifying at least one off-hour employee and at least one off-hour period identifying an off-hour period for the at least one off-hour employee;
determining restricted employer communications systems for the at least one off-hour employee from among the plurality of employer communications systems based on the received employee information for the at least one off-hour employee; and
instructing the restricted employer communications systems to restrict communications access of the at least one off-hour employee to the restricted employer communications systems during the at least one off-hour period for the at least one off-hour employee.
